(19) United States
(12) Patent Application Publication
(10) Pub. No.: US 2010/0064725 A1
(43) Pub. Date: Mar. 18, 2010

(54) METHOD AND APPARATUS FOR TREATING A HYDROCARBON STREAM

(76) Inventors: Jill Hui Chiun Chieng, The Hague (NL); Akash Damodar Wani, The Hague (NL)

Correspondence Address: SHELL OIL COMPANY, P O BOX 2463, HOUSTON, TX, 772522463, US

(21) Appl. No.: 12/446,622

(22) PCT Filed: Oct. 23, 2007
(86) PCT No.: PCT/EP2007/061331

§ 371 Date: Nov. 24, 2009

(30) Foreign Application Priority Data
Oct. 24, 2006 (EP) 06122790.6

(51) Int. Cl. F25J 3/00; B01D 53/18; B01D 19/00

(52) U.S. Cl. 62/620; 95/42; 96/218

(57) ABSTRACT

In a method of treating a hydrocarbon stream, such as a natural gas stream, a partly condensed feed stream (10) is supplied to a first gas/liquid separator (2), where it is separated into a gaseous stream (20) and a liquid stream (30). The liquid stream (30) is expanded and fed (40) into a second gas/liquid separator (3), and the gaseous stream (20) is split into at least two sub-streams (50, 70). A first sub-stream (50) of the at least two sub-streams is expanded, thereby obtaining an at least partially condensed first sub-stream (60), and subsequently fed (60) into the second gas/liquid separator (3). A second sub-stream (70) of the at least two sub-streams is cooled against a cold stream (120), thereby obtaining an at least partially condensed second sub-stream (90, 90a), which is fed (90, 90a) into the second gas/liquid separator (3) from which a gaseous stream (130) and a liquid stream (100, 100a) are removed. The at least partially condensed second sub-stream (90, 90a) may have a temperature of below −95° C.

The present invention relates to a method of treating a hydrocarbon stream such as a natural gas stream.

In particular the present invention relates to the treatment of a natural gas stream involving recovery of at least some of the ethane, propane, butanes and higher hydrocarbons such as pentane from the natural gas. The recovery of hydrocarbons may be done for several purposes. One purpose may be the production of hydrocarbon streams consisting primarily of hydrocarbons heavier than methane such as natural gas liquids (NGLs; usually composed of ethane, propane and butanes), liquefied petroleum gas (LPG; usually composed of propane and butane) or condensates (usually composed of butanes and heavier hydrocarbon components). Another purpose may be the adjustment of e.g. the heating value of the hydrocarbon stream to correspond to desired specifications.

Several processes and apparatuses for treating a hydrocarbon stream are known. An example is given in US 2005/0268469 A1 disclosing various line-ups for processing natural gas or other methane-rich gas streams to produce a liquefied natural gas (LNG) stream that has a high methane content and a liquid stream containing predominantly hydrocarbons heavier than methane.

A problem of the known method is that it is rather complicated thereby resulting in high capital expenses (CAPEX), but at the same time it does not obtain a satisfactory recovery of in particular ethane.

It is an object of the present invention to minimize the above problem, while at the same time maintaining or even improving the recovery of ethane and heavier hydrocarbons, in particular ethane, from the hydrocarbon stream.

The present invention provides a method of treating a hydrocarbon stream, such as a natural gas stream, the method at least comprising the steps of:

(a) supplying a partly condensed feed stream to a first gas/liquid separator;

(b) separating the feed stream in the first gas/liquid separator into a gaseous stream and a liquid stream;

(c) expanding the liquid stream obtained in step (b) and feeding it into a second gas/liquid separator;

(d) splitting the gaseous stream into at least two sub-streams;

(e) expanding a first sub-stream obtained in step (d), thereby obtaining an at least partially condensed first sub-stream, and subsequently feeding the at least partially condensed first sub-stream into the second gas/liquid separator;

(f) cooling a second sub-stream obtained in step (d) against a cold stream, thereby obtaining an at least partially condensed second sub-stream, and subsequently feeding the at least partially condensed second stream into the second gas/liquid separator;

(g) removing from the second gas/liquid separator a gaseous stream; and

(h) removing from the second gas/liquid separator a liquid stream.

The at least partially condensed second sub-stream obtained in step (f) may have a temperature of below −95° C.

In a further aspect the present invention provides an apparatus for treating a hydrocarbon stream, such as a natural gas stream, the apparatus at least comprising:

a first gas/liquid separator having an inlet for a partly condensed feed stream, a first outlet for a gaseous stream and a second outlet for a liquid stream;

a splitter connected to the first outlet of the first gas/liquid separator for splitting the gaseous stream into at least a first sub-stream and a second sub-stream;

a second gas/liquid separator having at least a first outlet for a gaseous stream and a second outlet for a liquid stream and first, second and third inlets;

a first expander connected to the second outlet of the first gas/liquid separator for expanding the liquid stream;

a second expander for expanding the first sub-stream obtained from the splitter;

a first heat exchanger between the splitter and an inlet of the second gas/liquid separator, in which first heat exchanger the second sub-stream can be cooled against a cold stream.

Preferably, this apparatus is suitable for performing the method according to the present invention.

The cold stream may suitably be obtained from a separate source of a liquefied hydrocarbon product, in particular LNG, for instance obtained from an LNG storage tank at an LNG import terminal.

In a group of embodiments, the gaseous stream removed from the second gas/liquid separator is warmed by heat exchanging against the second sub-stream, before the second sub-stream is cooled against the cold stream. According to an especially preferred embodiment the apparatus may therefore further comprise a second heat exchanger, arranged between the splitter and the first heat exchanger. The gaseous stream obtained from the first outlet of the second gas/liquid separator can be warmed against the second sub-stream in this second heat exchanger.

Hereinafter the invention will be further illustrated by way of example and with reference to the following non-limiting drawing. Herein shows:

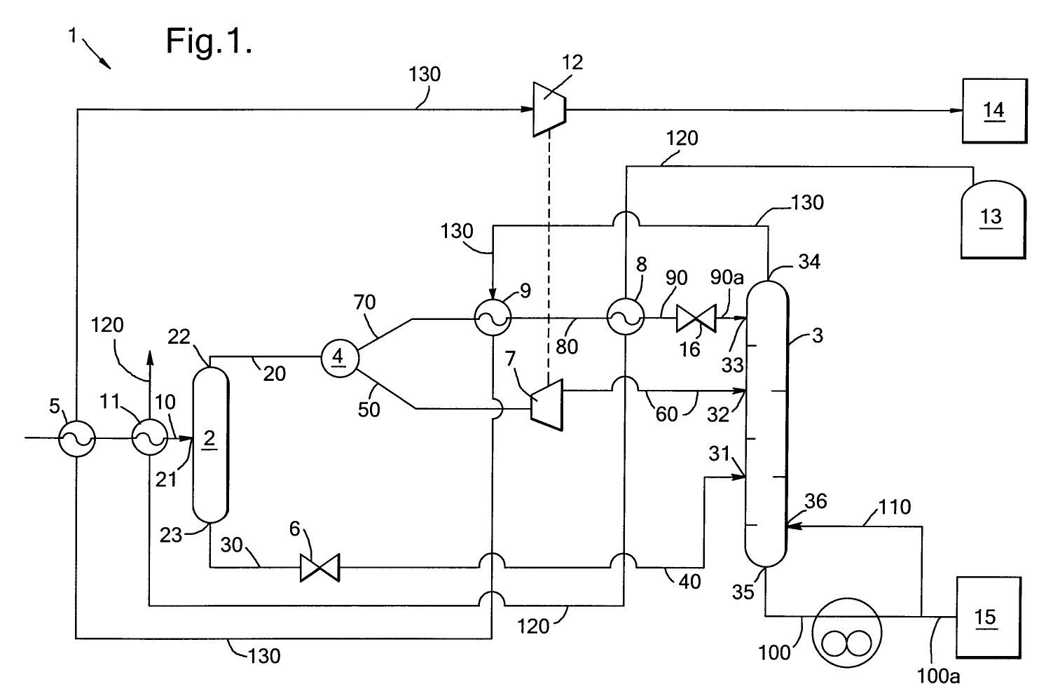

FIG. 1 schematically a process scheme in accordance with the present invention.

For the purpose of this description, a single reference number will be assigned to a line as well as a stream carried in that line. Same reference numbers refer to similar components.

The present invention seeks to provide an alternative method for treating a natural gas stream.

The invention involves separating, in a first gas/liquid separator, a partly condensed hydrocarbon feed stream into gaseous and liquid streams; expanding and feeding the liquid stream into a second gas/liquid separator; expanding and at least partially condensing the gaseous stream and feeding thereof into the second gas/liquid separator.

It has been found that using the surprisingly simple method according to the present invention, the CAPEX can be significantly lowered. Further, also due to its simplicity, the method according to the present invention and apparatuses for performing the method have proven very robust when compared with known line-ups. A special advantage according to the present invention is that no partial reflux of the gaseous stream obtained from the second gas/liquid separator (usually a ‘de-methanizer’) is necessary.

Furthermore it has been found that according to the present invention a higher ethane recovery can be obtained thereby resulting in a leaner methane-rich natural gas stream (that may be liquefied subsequently, if desired). The method according to the present invention has also been proven suitable for feed streams having a pressure well below 70 bar, at the same time keeping up a relatively high ethane recovery.

The hydrocarbon stream may be any suitable hydrocarbon-containing stream to be treated, but is usually a natural gas stream obtained from natural gas or petroleum reservoirs. As an alternative the natural gas stream may also be obtained from another source, also including a synthetic source such as a Fischer-Tropsch process.

Usually the hydrocarbon feed stream is comprised substantially of methane. Preferably the hydrocarbon stream comprises at least 60 mol % methane, more preferably at least 80 mol % methane.

Depending on the source, the hydrocarbon feed stream may contain varying amounts of hydrocarbons heavier than methane such as ethane, propane, butanes and pentanes as well as some aromatic hydrocarbons. The hydrocarbon feed stream may also contain non-hydrocarbons such as H₂O, N₂, CO₂, H₂S and other sulphur compounds, and the like. If desired, the hydrocarbon feed stream may be pre-treated before feeding it to the first gas/liquid separator. This pre-treatment may comprise removal of undesired components such as CO₂ and H₂S, or other steps such as pre-cooling, pre-pressurizing or the like. As these steps are well known to the person skilled in the art, they are not further discussed here.

Preferably the partially condensed feed stream has a pressure >20 bar, preferably from 25 to 100 bar, more preferably from 30 to 50 bar, most preferably about 35 bar.

The first and second gas/liquid separator may be any suitable means for obtaining a gaseous stream and a liquid stream, such as a scrubber, distillation column, etc. If desired, three or more gas/liquid separators may be present.

It is preferred that the second gas/liquid separator is a so-called ‘de-methanizer’. To this end, preferably >75 mol % of the ethane present in the partially condensed feed stream is recovered in the liquid stream obtained in step (h), preferably >80, more preferably >85, even more preferably >90, most preferably >95 mol %.

Also, the person skilled in the art will understand that the steps of expanding may be performed in various ways using any expansion device (e.g. using a throttling valve, a flash valve or a common expander).

In a step (d) the gaseous stream is split into at least first and second sub-streams. The splitting in step (d) to obtain at least two sub-streams may be performed in various ways. Just after splitting, the sub-streams have preferably substantially the same composition and phase condition, although the two or more sub-streams may have different flow amounts.

Also it is preferred that in step (d) a split ratio is used such that a ratio for the second sub-stream to the gaseous stream (just before splitting) is obtained in the range of 0.3 to 0.9, preferably in the range of 0.35-0.65, more preferably about 0.5.

In a step (f) the second sub-stream obtained in said step (d) is cooled against a cold stream, thereby obtaining an at least partially condensed second sub-stream that can have a temperature of below −95° C.

The person skilled in the art will understand that the temperature of below −95° C. of the at least partially condensed second sub-stream may be obtained in various ways by properly tailoring the ratio of the sub-streams at the splitter, the temperature of the cold stream, the amount and flow rate of the various streams, etc.

Preferably the at least partially condensed second sub-stream obtained in step (f) has a temperature below −100° C., preferably below −110° C. Preferably the at least partially condensed second sub-stream obtained in step (f) has a temperature of below −95° C., −100° C., or −110° C., and above −125° C., more preferably above −120° C., most preferably about −115° C.

Although the cold stream can be obtained from several sources it is preferred that the cold stream is not a refrigerant stream being cycled in a closed refrigerant cycle. Preferably the cold stream is obtained from a separate source of a liquefied hydrocarbon product such as LNG, preferably from an LNG storage tank at an LNG import terminal. With ‘separate source’ for the cold stream is meant that preferably no cold stream is used that is generated during the treating itself or downstream of the treating.

In a step (g) a gaseous stream is removed from the second gas/liquid separator and in a step (h) a liquid stream is removed from the second gas/liquid separator.

It is preferred that the gaseous stream removed from the second gas/liquid separator in step (g) is warmed by heat exchanging against the second sub-stream before the second sub-stream is cooled against the cold stream.

Further it is preferred that the pressure in the second gas/liquid separator is from 15 to 30 bar, preferably from 18 to 25 bar, more preferably about 20 bar.

Although the gaseous stream obtained in step (g) may be used for various purposes it is preferably sent to a gas network. Alternatively it may e.g. be liquefied thereby obtaining a liquefied hydrocarbon stream such as liquefied natural gas (LNG).

The person skilled in the art will readily understand that the treated hydrocarbon stream may be further processed, if desired. Also, further intermediate processing steps between the first and second gas/liquid separator may be performed, although it is preferred to keep the scheme as simple as possible.

Further, the liquid stream removed from the bottom of the second gas/liquid separator is preferably subjected to fractionation thereby obtaining two or more fractionated streams.

In a special embodiment the partially condensed feed stream has been previously cooled against a cold stream, preferably against a cold stream that has been obtained from a separate source of a liquefied hydrocarbon product, in particular LNG, preferably obtained from an LNG storage tank at an LNG import terminal.

FIG. 1 schematically shows a process scheme (generally indicated with reference no. 1) for the treating of a hydrocarbon stream such as natural gas whereby ethane and heavier hydrocarbons are recovered to a certain extent.

The process scheme of FIG. 1 comprises a first gas/liquid separator 2, a second gas/liquid separator 3 (in the form of a distillation column, preferably a so-called ‘de-methanizer’), a stream splitter 4, a first expander 6 (preferably in the form of a throttling valve such as a Joule-Thomson valve), a second expander 7, a first heat exchanger 8, an optional second heat exchanger 9, a source 13 of a cold stream (in the embodiment of FIG. 1 embodied as a separate source, in the form of an LNG storage tank at an LNG import terminal), a gas network 14 and an optional fractionation unit 15. The person skilled in the art will readily understand that (as is also shown in FIG. 1) further elements may be present if desired.

The splitter 4 may be any suitable means allowing to obtain at least two sub-streams in a desired ratio. Preferably, the split sub-streams obtained have substantially the same composition.

During use, a partly condensed feed stream 10 containing natural gas is supplied to the inlet 21 of the first gas/liquid separator 2 at a certain inlet pressure and inlet temperature. Typically, the inlet pressure to the first gas/liquid separator 2 will be between 10 and 100 bar, preferably above 20 bar and below 90 bar, more preferably below 70 bar, even more preferably below 40 bar. The temperature will usually between 0 and −60° C., more preferably between −20 and −40° C., most preferably about −30° C. To obtain the partly condensed feed stream 10, it may have been pre-cooled in several ways. In the embodiment of FIG. 1, the feed steam 10 has been previously heat exchanged in heat exchanger 5 against stream 130 (an option which will be discussed hereafter) and subsequently in heat exchanger 11 against cold stream 120 originating from the LNG storage tank 13. It goes without saying that in the heat exchanger 11 instead of stream 120 a common external refrigerant such as propane or an other cooler such as an air or water cooler may be used.

If desired the feed stream 10 may have been further pre-treated before it is fed to the first gas/liquid separator 2. As an example, CO₂, H₂S and hydrocarbon components having the molecular weight of pentane or higher may also at least partially have been removed from the feed stream 10 before entering the first separator 2.

In the first gas/liquid separator 2, the feed stream 10 (fed at inlet 21) is separated into a gaseous overhead stream 20 (removed at first outlet 22) and a liquid bottom stream 30 (removed at second outlet 23).

The overhead stream 20 is enriched in methane (and usually also ethane) relative to the feed stream 10.

The bottom stream 30 is generally liquid and usually contains some components that are freezable when they would be brought to a temperature at which methane is liquefied. The bottom stream 30 may also contain hydrocarbons that can be separately processed to form liquefied petroleum gas (LPG) products. The stream 30 is expanded in the first expander 6 to the operating pressure of the distillation column 3 (usually about 20 bar) and fed into the same at the first inlet 31 as stream 40. If desired a further heat exchanger (not shown) may be present on line 40 to heat the stream 40. The first expander 6 may be any expansion device such as a common expander as well as a flash valve.

The gaseous overhead stream 20 removed at the first outlet 22 of the first separator 2 is split in splitter 4 at a pre-selected ratio thereby obtaining at least first sub-stream 50 and second sub-stream 70. If desired, more than two sub-streams may be obtained using the splitter 4.

The first sub-stream 50 is at least partially condensed in the second expander 7 and subsequently fed as stream 60 into the distillation column 3 at a second inlet 32, the second inlet 32 being preferably at a higher level than the first inlet 31. If desired a further heat exchanging step may take place between the second expander 7 and the second inlet 32.

The second sub-stream 70 is cooled in second heat exchanger 9 (against stream 130) and—as stream 80—in first heat exchanger 8 (against cold stream 120) and subsequently (as stream 90a) fed into the distillation column at a third inlet 33, the third inlet 33 being at a higher level than the second inlet 32. Said cooling in the second heat exchanger 9 is optional. Preferably the third inlet 33 is at the top of the distillation column 3. Usually the stream 90a is, before feeding into the distillation column 3, previously expanded (as stream 90), e.g. in a Joule-Thomson valve 16.

Preferably the amount, flow rate and temperature of the various streams are selected such that the at least partially condensed second sub-stream 90 being fed at third inlet 33 of the distillation column 3 has a temperature below −95° C., preferably below −100° C., more preferably below −110° C. and preferably above −125° C., more preferably above −120° C., most preferably about −115° C.

Preferably, the pressure in the distillation column 3 is from 15 to 30 bar, preferably from 18 to 25 bar, more preferably about 20 bar.

From the top of the distillation column 3, at first outlet 34, a gaseous overhead stream 130 is removed that is heat exchanged in second heat exchanger 9 against the second sub-stream 70, and subsequently in heat exchanger 5 against the feed stream. These heat exchange steps are optional.

The gaseous stream 130 obtained, optionally after having been warmed in second heat exchanger 9 and/or in heat exchanger 5, may be forwarded to the gas network 14 after optionally compressing in compressor 12 (which may be functionally coupled to second expander 7). Instead the stream 130 may be liquefied in a liquefaction unit (not shown) using one or more heat exchangers thereby obtaining LNG. As the person skilled in the art knows how to liquefy a hydrocarbon stream, this is not further discussed here.

Usually, a liquid bottom stream 100 is removed from the second outlet 35 of the distillation column 3 and is subjected to one or more fractionation steps in a fractionation unit 15 to collect various natural gas liquid products. As the person skilled in the art knows how to perform fractionation steps, this is not further discussed here.

If desired, and as shown in FIG. 1, a part of the liquid bottom stream 100 may be returned to the bottom of the distillation column 3 (at inlet 36) as stream 110, the remainder of stream 100 being indicated with stream 100a.

Table I gives an overview of the pressures and temperatures of a stream at various parts in an example process of FIG. 1. Also the mole % of ethane is indicated. The feed stream in line 10 of FIG. 1 comprised approximately the following composition: 79 mol % methane, 10 mol % ethane, 6 mol % propane, 3% butanes and pentane and 2% N₂. Other components such as CO₂, H₂S and H₂O were previously removed. The ratio of stream 70 to 20 was about 0.5 (i.e. the stream 20 was split into two equal streams 50 and 70).

TABLE I

| | Pressure | Temperature | Mole % | |
|---|---|---|---|---|
| Line | (bar) | (° C.) | ethane | Phase* |
| 10 | 35.5 | −30.0 | 9.5 | V/L |
| 20 | 35.4 | −30.1 | 8.3 | V |
| 30 | 35.4 | −30.1 | 19.2 | L |
| 40 | 20.2 | −38.0 | 19.2 | V/L |
| 50 | 35.4 | −30.1 | 8.3 | V |
| 60 | 20.2 | −52.2 | 8.3 | V/L |
| 70 | 35.4 | −30.1 | 8.3 | V |
| 80 | 35.1 | −81.2 | 8.3 | V/L |
| 90 | 34.7 | −115.0 | 8.3 | V/L |
| 90a | 20.2 | −115.0 | 8.3 | V/L |
| 100 | 20.2 | −115.0 | 8.3 | V/L |
| 110 | 20.2 | 20.0 | 50.1 | L |

*V = vapour; L = liquid

As a comparison the same line-up as FIG. 1 was used, but instead a warmer temperature for stream 90a was used, viz. −80° C. instead of −115° C. It was found that according to the present invention a significantly higher ethane recovery (96%) was obtained in stream 100a, whilst the same line-up with a higher temperature for stream 90 (viz. −80° C.) resulted in a ethane recovery of only 50%. This is shown in Table II.

TABLE II

| | | | Molar fraction of |
|---|---|---|---|
| | | Molar fraction | stream 100a in FIG. 1 |
| | Molar fraction | of stream 100a | with a temperature |
| | of stream 10 | in FIG. 1 (present | of −80° C. for stream |
| Component | in FIG. 1 | invention) | 90 (comparison) |
| Flow rate | 7.926 | 1.44 | 1.082 |
| [kmol/s] | | | |
| Methane | 0.794 | 0.005 | 0.004 |
| Ethane | 0.095 | 0.502 | 0.351 |
| Propane | 0.056 | 0.305 | 0.395 |
| i-Butane | 0.013 | 0.073 | 0.098 |
| Butane | 0.011 | 0.062 | 0.082 |
| i-Pentane | 0.004 | 0.020 | 0.027 |
| Pentane | 0.002 | 0.013 | 0.017 |
| % Ethane | | 96% | 50% |
| recovery | | | |

The person skilled in the art will readily understand that many modifications may be made without departing from the scope of the invention. As an example, the compressors may comprise two or more compression stages.

Further, each heat exchanger may comprise a train of heat exchangers.

1. Method of treating a hydrocarbon stream, the method at least comprising the steps of:
(a) supplying a partly condensed feed stream to a first gas/liquid separator;
(b) separating the feed stream in the first gas/liquid separator into a gaseous stream and a liquid stream;
(c) expanding the liquid stream obtained in step (b) and feeding it into a second gas/liquid separator;
(d) splitting the gaseous stream into at least two sub-streams;
(e) expanding a first sub-stream obtained in step (d), thereby obtaining an at least partially condensed first sub-stream, and subsequently feeding it into the second gas/liquid separator;
(f) cooling a second sub-stream obtained in step (d) against a cold stream, thereby obtaining an at least partially condensed second sub-stream, and subsequently feeding the at least partially condensed second sub-stream into the second gas/liquid separator;
(g) removing from the second gas/liquid separator a gaseous stream; and
(h) removing from the second gas/liquid separator a liquid stream.

2. Method according to claim 1, wherein the at least partially condensed second sub-stream obtained in step (f) has a temperature below −95° C.

3. Method according to claim 2, wherein said temperature is above −125° C.

4. Method according to claim 1, wherein the gaseous stream removed from the second gas/liquid separator in step (g) is warmed by heat exchanging against the second sub-stream before the second sub-stream is cooled against the cold stream.

5. Method according to claim 1, wherein in step (d) a split ratio is used such that a ratio for the second sub-stream to the gaseous stream is obtained in the range of 0.3 to 0.9.

6. Method according to claim 1, wherein the cold stream is not a refrigerant stream being cycled in a closed refrigerant cycle.

7. Method according to claim 1, wherein the cold stream is obtained from a separate source of a liquefied hydrocarbon product.

8. Method according to claim 1, wherein >75 mol % of the ethane present in the partially condensed feed stream is recovered in the liquid stream obtained in step (h).

9. Method according to claim 1, wherein the pressure in the second gas/liquid separator is from 15 to 30 bar.

10. Method according to claim 1, wherein at least a part of the gaseous stream obtained in step (g) is sent to a gas network.

11. Method according to claim 1, wherein at least a part of the gaseous stream obtained in step (g) is liquefied thereby obtaining a liquefied hydrocarbon stream.

12. Method according to claim 1, wherein at least a part of the liquid stream removed from the bottom of the second gas/liquid separator is subjected to fractionation thereby obtaining two or more fractionated streams.

13. Method according to claim 1, wherein the partially condensed feed stream has been previously cooled against a cold stream.

14. Apparatus for treating a hydrocarbon stream, the apparatus at least comprising:
a first gas/liquid separator having an inlet for a partly condensed feed stream, a first outlet for a gaseous stream and a second outlet for a liquid stream;
a splitter connected to the first outlet of the first gas/liquid separator for splitting the gaseous stream into at least a first sub-stream and a second sub-stream;
a second gas/liquid separator having at least a first outlet for a gaseous stream and a second outlet for a liquid stream and first, second and third inlets;
a first expander connected to the second outlet of the first gas/liquid separator for expanding the liquid stream;
a second expander for expanding the first sub-stream obtained from the splitter;
a first heat exchanger between the splitter and an inlet of the second gas/liquid separator, in which first heat exchanger the second sub-stream can be cooled against a cold stream.

15. Apparatus according to claim 14, wherein the cold stream can be obtained from a separate source of a liquefied hydrocarbon product.

16. Apparatus according to claim 14, further comprising a second heat exchanger between the splitter and the first heat exchanger, in which second heat exchanger the gaseous stream obtained from the first outlet of the second gas/liquid separator can be warmed against the second sub-stream.

17. Method according to claim 1, wherein the at least partially condensed second sub-stream obtained in step (f) has a temperature below −100° C.

18. Method according to claim 1, wherein the at least partially condensed second sub-stream obtained in step (f) has a temperature below −110° C.

19. Method according to claim 17, wherein said temperature is above −125° C.

20. Method according to claim 18, wherein said temperature is above −125° C.
